(19) United States
(12) Patent Application Publication
(10) Pub. No.: US 2008/0044255 A1
(43) Pub. Date: Feb. 21, 2008

(54) Plastic clip for fastening an object to a stud and fastening arrangement using such clip

(76) Inventor: Frank Rosemann, Munzenberg (DE)

Correspondence Address: MILES & STOCKBRIDGE PC, 1751 PINNACLE DRIVE, SUITE 500, MCLEAN, VA, 22102-3833, US

(21) Appl. No.: 11/892,169

(22) Filed: Aug. 20, 2007

(30) Foreign Application Priority Data
Aug. 21, 2006 (DE) 10 2006 038 991.3

(51) Int. Cl. F16B 19/00

(52) U.S. Cl. 411/508

(57) ABSTRACT

A plastic clip (4) for fastening an object (3) having a fastening aperture (7) to a support (1) provided with a stud (2), has a shank portion (14) with an aperture (15) for accommodating the stud (2), a flange at a first end (16) of the shank portion (14), with a larger diameter than the fastening aperture (7), at least one first locking finger (19) to engage with an engagement step (8) of the stud (2), and at least one second locking finger (22) to engage with the object.

### CROSS REFERENCE TO RELATED APPLICATION

This application claims the benefit of German Patent Application No. 10 2006 038 991.3 of Aug. 21, 2006, incorporated herein by reference.

### BACKGROUND OF THE INVENTION

This invention concerns a plastic clip for fastening an object having a fastening aperture to a support provided with a stud, in particular a T-stud, and also concerns a fastening arrangement using such clip.

Plastic clips of the specified type are often used in automotive manufacture for fastening trim parts and attached parts. They are known in a variety of designs, for example from DE 3,540,867 C2, DE 198 57 372 C1, and DE 199 29 924 A1.

### BRIEF DESCRIPTION OF THE INVENTION

An object of the invention is to provide a clip of the specified type that is pre-installed on an object to be fastened and that can then be installed together therewith on a support. The clip of the invention is able to compensate for variations in the position of the stud on the support resulting from the manufacturing process, and is distinguished by a small space requirement in the direction of the stud axis. Finally, the clip is easy and economical to manufacture.

The invention provides a plastic clip for fastening an object having a fastening aperture to a support provided with a stud, in particular a T-stud, the clip having a shank portion that has an aperture for accommodating the stud, having a flange at a first end of the shank portion with a larger diameter than the fastening aperture, having at least one first locking finger to engage with an engagement step of the stud, and having at least one second locking finger to engage with the object.

The inventive clip can be pre-installed on the object to be fastened, the clip being held on the object with the aid of the flange and at least one second locking finger. The clip can then be installed on the support together with the object. During this process, the stud enters the aperture of the shank portion and centers itself therein. Pressing the clip against the support causes the at least one first locking finger to latch into an engagement step of the stud, thus anchoring the object on the support. A short overall length of the clip in the axial direction results from the arrangement of the locking fingers, with one directed inward and one directed outward. Furthermore, because of their elasticity, the locking fingers permit compensation of manufacturing tolerances with regard to the position of the stud and the object on the support.

According to an aspect of the invention, the flange is formed as a spring washer whose diameter increases with distance in the axial direction from the first end of the shank. It is thus possible to compensate for tolerances resulting from the manufacturing process relating to the distance of the stud's engagement step from the contact surface of the support. In addition, the spring washer makes it possible to produce an axial preloading between parts that are joined to one another, thereby avoiding rattling noises under the influence of vibration. Furthermore, the spring washer provides an axial bracing of the clip and the object so that the clip is securely held on the object during transport. The spring washer is advantageously formed such that it has a relatively small wall thickness in an outer contact region, so that it can be bent easily there for installation. The wall thickness increases considerably, especially in the region of the connection to the shank portion. This makes possible a high retention strength in the event of a tensile load directed against the spring washer that originates from a fastened object.

According to another aspect of the invention, the at least one first locking finger has at a free end a first locking surface extending in a radial direction with respect to a center axis of the clip, and has a second locking surface extending in an axial direction. In this way, the end of the locking finger is supported against the stud under load in both the axial and radial directions, so that high retention forces can be provided. In addition, the radial support of the locking finger can serve to orient the clip with respect to the stud.

According to the invention, the at least one second locking finger has a centering rib extending axially, permitting centering of the clip in the fastening aperture.

According to another aspect of the invention, to facilitate installation of the clip on the stud, guide surfaces are formed in the aperture of the shank portion, these guide surfaces having a shape such that a gap between the guide surfaces diminishes toward the first end of the shank portion. Furthermore, guide bevels may be formed on the second end of the shank portion. By virtue of this measure, the introduction of the stud into the aperture of the shank portion is made significantly easier, while partial centering of the clip with respect to the stud is achieved at the same time. The guide surfaces can also constitute a stop for the head end, so that lateral forces can be borne by the guide surfaces, and the at least first locking finger does not have to absorb these forces.

Preferably the clip has two opposing first locking fingers in a first radial plane, and two opposing second locking fingers in a second radial plane at right angles to the first plane. Due to this arrangement, first and second locking fingers can be arranged next to one another, and tolerance compensation can be achieved in all radial directions with the aid of the locking fingers.

Another aspect of the invention is that the spring washer has a recess in the region of the axial projection of the at least second locking finger. Economical manufacture of the clip using a two-part mold is made possible by this means.

The invention also concerns a fastening arrangement comprising an inventive clip and an object with a fastening aperture, wherein a recess is formed in a wall of the fastening aperture and wherein the clip inserted in the fastening aperture makes contact by means of the flange with a wall region surrounding the fastening aperture and engages with the recess by means of a locking tooth of the at least one second locking finger.

The inventive fastening arrangement is easy to install and provides a reliable connection of clip and object for transport of the same to a fastening location.

Preferably, the fastening aperture of the object is a slot, wherein the recess is arranged on one longitudinal side of the slot and has an extent in the longitudinal direction of the fastening aperture that is greater than the width of the locking finger, and wherein the contact surface for the clip's flange in the form of a spring washer has raised bumps against which the edge of the spring washer can be laterally supported when the spring washer is located in a centered position with respect to the fastening aperture. As a result of this design, the clip in the pre-installed center position is held sufficiently securely that it cannot shift during transport. During installation on the support, however, the clip can be shifted in the longitudinal direction of the fastening aperture in order to compensate for dimensional variations, with the spring washer being pushed over the bumps.

### BRIEF DESCRIPTION OF THE DRAWINGS

The invention will be further described in conjunction with the accompanying drawings, which illustrate a preferred (best mode) embodiment, wherein:

FIG. 1 is a longitudinal section of a fastening arrangement according to the invention taken along line I-I in FIG. 3, FIG. 2 is a longitudinal section of the fastening arrangement taken along line II-II in FIG. 3, and

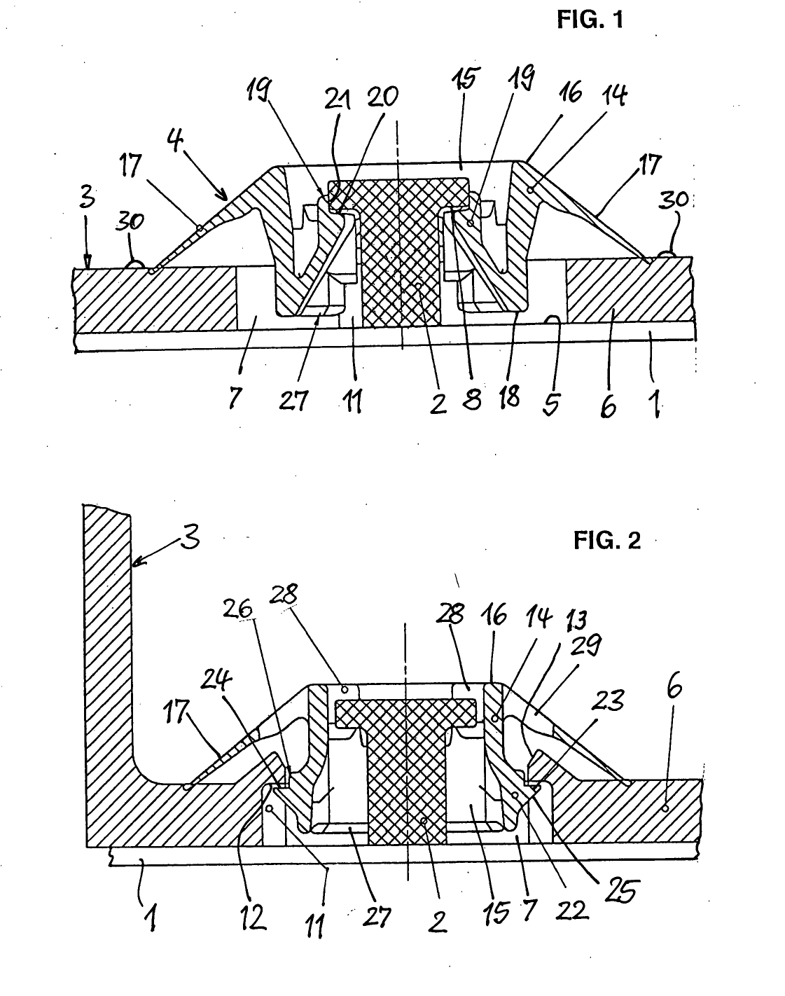

FIG. 3 is a view from below the fastening arrangement after removal of the support.

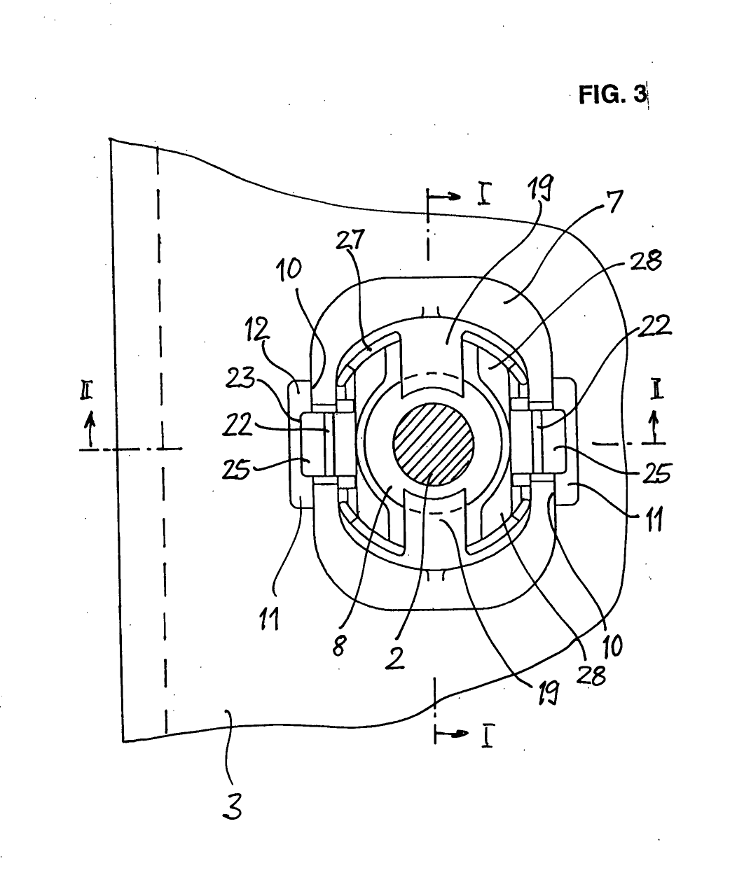

### DETAILED DESCRIPTION OF THE INVENTION

The fastening arrangement shown comprises a support 1, a stud 2 attached thereto, for example by welding, an object 3, and a clip 4 which secures the object 3 to the support 1. The support 1 has a flat contact surface 5 surrounding the stud 2, and a wall 6 of the object 3 makes contact therewith. Passing all the way through the wall 6 is a fastening aperture 7, in which are arranged the clip 4 and the stud 2.

The stud 2 is in the form of a T-stud with a head of larger diameter whose edge region constitutes an engagement step 8 with a surface facing the support 1. The fastening aperture 7 is designed as a slot with two parallel, straight wall sections 10. Each of the wall sections 10 has a recess 11, which extends to the underside of the wall 6 in contact with the support 1, and which constitutes a support surface 12 facing the underside and at right angles to the axis of the fastening aperture 7. The top edge of the fastening aperture 7 is provided with guide bevels 13 in the region adjacent to the recesses 11.

The clip 4 has a ring-shaped shank portion 14 with a central aperture 15, which serves to accommodate the stud 2. Provided at a first end 16 of the shank portion 14 is an outwardly extending flange, which is formed as a spring washer 17 and surrounds the shank portion 14 on all sides. The spring washer 17 has a conical shape such that its diameter increases with distance from the first end 16 in the axial direction. In addition, the wall thickness of the spring washer 17 decreases as the diameter increases, so that the outer edge region is more flexible.

Formed on the shank portion 14 at an end 18 opposite the end 16, in a symmetrical arrangement opposite one another, are first resilient locking fingers 19, which extend inward and toward the first end 16 at an angle with respect to the center axis of the shank portion 14. At their free ends, the locking fingers 19 have a first, flat locking surface 20 extending in a radial direction, and a second locking surface 21, with a concave curvature, extending in an axial direction. The locking surfaces 21 of the two locking fingers 19 face one another, and the distance between them corresponds to the diameter of the head of the stud 2. The first locking surfaces 20 extend radially inward from the second locking surfaces 21.

Second resilient locking fingers 22 are additionally formed on the shank portion 14, offset by 900 in the circumferential direction from the first locking fingers 19. Each locking finger 22 has a radially outward-extending locking tooth 23 with a locking surface 24 facing the flange, and a tapered sliding surface 25 facing away from the flange and inclined toward the center axis. In each case, the locking surface 24 is bounded radially toward the inside by a stop rib 26, which extends parallel to the center axis and toward the spring washer 17. The spacing between the stop ribs 26 of the two locking fingers 22 corresponds to the width of the fastening aperture 7 between the wall sections 10. The width of the locking fingers 22 and their locking teeth 23 is smaller than the width of the recesses 11 so that the clip can be pushed axially into the fastening aperture 7 in the long direction.

The aperture 15 bounded by the shank portion 14 including the locking fingers 22 has a diameter at its second end 18 that is significantly larger than the diameter of the head of the stud 2. Placement of the clip 4 on the stud 2 is made easier by this means. Moreover, guide bevels 27 are provided on the edge of the aperture 15. The inside diameter of the shank portion 14 tapers down toward the first end 16, where guide surfaces 28 are formed. The diameter of the space between the guide surfaces 28 is only greater than the diameter of the head of the stud 2 by the clearance required to compensate for manufacturing tolerances. In the area of motion of the first locking fingers 19, the guide surfaces 28 are recessed so that the locking fingers 19 have sufficient clearance during installation to be able to give way to the entering stud head.

The spring washer 17 has two recesses 29, which are at least as large as the axial projection of the locking fingers 22 including their locking teeth 23. This makes it possible to mold the clip 4 in a two-part mold.

Installation of the fastening arrangement takes place in two steps. In the first step, the clip 4 is installed on the object 3. To this end, the clip 4 is aligned with respect to the fastening aperture 7 such that the locking fingers 22 are lined up with the longitudinal sides of the fastening aperture 7. Then the clip 4 is pressed into the fastening aperture 7, during which process the guide bevels 13 engage with the sliding surfaces 25 so that the locking fingers 22 are bent radially inward far enough that their locking teeth 23 enter the aperture and finally latch into the recesses 11. At the same time, the spring washer 17 makes contact with the wall 6, causing the spring washer to be bent slightly. After pressure on the clip 4 is released, the spring washer 17 springs back slightly, thereby pressing the locking surfaces 24 of the locking teeth 23 against the support surfaces 12 of the recesses 11. At the same time, the stop ribs 26 provide for centering of the clip 4 in the fastening aperture 7 in the transverse direction. In the longitudinal direction, the clip 4 is held in a centered position by raised bumps 30, against which the circumferential edge of the spring washer 17 is supported. In this pre-installed position, the clip 4 is securely held on the object 3, so that the object can be transported to an installation location without the clip changing its position in the fastening aperture 7.

In the second step, installation of the object 3 with the clip 4 on the support 1 takes place, wherein the object 3 and clip 4 are oriented with respect to the stud 2 and then pressed onto the support 1. During this process, the head of the stud 2 is guided by the aperture 15 and the guide surfaces 28, and the locking fingers 19 are spread apart by the head entering the aperture 15 until they spring back into their initial position and their locking surfaces 20 interlock with the engagement step 8 upon reaching the final installed position. The locking surfaces 21 come into contact with the peripheral surface of the stud head, thereby radially supporting the locking fingers 19 on the inner side against the stud 2. Consequently, forces acting on the clip 4 in the release direction cannot lead to radially inward deformation of the locking fingers 19, so the clip 4 can provide high retention forces. Upon reaching the final installed position, the spring washer 17 is bent even more strongly, thus bracing the clip 4, the object 3, and the support 1 against each other in the axial direction.

If the intended installation position of the object 3 differs more strongly—relative to the center of the fastening aperture 7—from the position of the stud 2 in the longitudinal direction of the fastening aperture 7, the clip 4 can be shifted accordingly in the fastening aperture 7, with the spring washer 17 being pushed over the bumps 30 during the process. Compensation for relatively great dimensional variations in a simple way is made possible by this means.

The fastening arrangement described is distinguished by low installation forces and relatively high retention forces. It permits simple pre-installation of the clip on the object to be fastened, and permits compensation of manufacturing tolerances. In addition, the clip and the fastening aperture in the object can be produced simply and economically.

While a preferred embodiment of the invention has been shown and described, changes can be made without departing from the principles and spirit of the invention, the scope of which is defined in the accompanying claims.

What is claimed is:

1. Plastic clip (4) for fastening an object (3) having a fastening aperture (7) to a support (1) provided with a stud (2), said clip having a shank portion (14) that has an aperture (15) for accommodating the stud (2), having a flange at a first end (16) of the shank portion (14), at least one first locking finger (19) on the shank portion (14) that has a first surface (20) extending inward and facing toward the first end of the shank portion (14), disposed to engage an engagement step (8) of the stud (2), and having at least one second locking finger (22) on the shank portion (14) that has a first surface (24) extending outward and facing toward the first end of the shank portion (14) and disposed to engage the object (3).

2. Clip according to claim 1, characterized in that the flange is a spring washer (17) whose diameter increases with distance in an axial direction from the first end (16) of the shank portion (14).

3. Clip according to claim 2, characterized in that the spring washer (17) has a wall thickness in an outer contact region that increases toward a region of connection to the shank portion (14).

4. Clip according to claim 1, characterized in that the at least one first locking finger (19) has a second surface (21) extending in an axial direction of the clip and facing inward.

5. Clip according to claim 1, characterized in that the at least one second locking finger (22) has a stop rib (26) extending in an axial direction for centering of the clip (4) in the fastening aperture (7).

6. Clip according to claim 1, characterized in that the at least one second locking finger (22) has a sliding surface (25) facing away from the flange and inclined toward a center axis of the clip.

7. Clip according to claim 1, characterized in that guide surfaces (28) are formed in the aperture (15) of the shank portion (14), said guide surfaces having a shape such that a gap between the guide surfaces diminishes toward the first end of the shank portion (14).

8. Clip according to claim 1, characterized in that guide bevels (27) are formed on a second end of the shank portion (14).

9. Clip according to claim 1, characterized in that the clip (4) has two opposing first locking fingers (19) in a first radial axial plane and two opposing second locking fingers (22) in a second radial axial plane at right angles to the first plane.

10. Clip according to claim 2, characterized in that the spring washer (17) has a recess in a region of an axial projection of the at least one second locking finger (22).

11. Clip according to claim 4, wherein the stud (2) is a T-stud and the first and second surfaces (20) and (21) of the at least one first locking finger (19) are disposed to engage respective bottom and peripheral surfaces of a head of the T-stud.

12. Clip according to claim 1, characterized in that the at least one second locking finger (22) has a second surface (26) facing outward of the shank portion (14), and wherein the first and second surfaces of the at least one second locking finger are disposed to engage respective radial and axial surfaces in the aperture (7) of the object (6).

13. Fastening arrangement comprising a clip (4) according to claim 1, and an object (3) with a fastening aperture (7), wherein a recess (11) is formed in a wall of the fastening aperture (7) and wherein the clip (4) inserted in the fastening aperture (7) makes contact by means of the flange with a wall region surrounding the fastening aperture (7) and engages with the recess (11) by means of a locking tooth (23) of the at least one second locking finger (22).

14. Fastening arrangement according to claim 13, characterized in that the fastening aperture (7) of the object (3) is a slot, wherein the recess (11) is arranged on one longitudinal side of the slot and has an extent in a longitudinal direction of the fastening aperture (7) that is greater than the width of the at least one second locking finger (22), and wherein a contact surface for the flange of the clip (4) in the form of a spring washer (17) has raised bumps (30) against which the edge of the spring washer (17) is laterally supported when the spring washer (17) is located in a centered position with respect to the fastening aperture (7).
